(19) United States
(12) Patent Application Publication
(10) Pub. No.: US 2015/0374026 A1
(43) Pub. Date: Dec. 31, 2015

(54) EASY-TO-OPEN ROASTED OR BOILED AROMATIC COCONUT AND THE METHOD FOR PRODUCING THE SAME

(71) Applicant: COCO EASY CO., LTD., Patumthani (TH)

(72) Inventor: Banphot KLIAPHUANGPHIT, Nonthaburi (TH)

(73) Assignee: COCO EASY CO., LTD., Patumthani (TH)

(21) Appl. No.: 14/769,376

(22) PCT Filed: Feb. 11, 2014
(86) PCT No.: PCT/TH2014/000005

§ 371 Date: Aug. 20, 2015

(30) Foreign Application Priority Data
Feb. 21, 2013 (TH) 1303000189

(51) Int. Cl. A23N 5/03; A23L 1/212

(52) U.S. Cl. CPC A23N 5/03; A23L 1/212; A23V 2002/00

(57) ABSTRACT

An easy-to-open aromatic coconut is provided that includes, but is not limited to a coconut from which the husk was removed until a clean shelled coconut is obtained and groove line on the shell of the coconut. The groove line is at least one converged groove line located at the bottom of the shell of the coconut and the groove line is made by laser engraving using a laser engraver. The easy-to-open aromatic coconut also includes, but is not limited to an opening device fixed within one converged groove line, near the groove line. A method for producing the easy-to-open aromatic coconut is also provided that allows a consumer to open the coconut shell by pulling the opening device.

### CROSS-REFERENCE TO RELATED APPLICATIONS

This application is a U.S. National-Stage entry under 35 U.S.C. §371 based on International Application No. PCT/TH2014/000005, filed Feb. 11, 2014 which was published under PCT Article 21(2) and which claims priority to Thailand Application No. 1303000189, filed Feb. 21, 2013, which are all hereby incorporated in their entirety by reference.

### TECHNICAL FIELD

The technical field relates to easy-to-open roasted or boiled aromatic coconut and the method for producing the same

### BACKGROUND

In present days, most roasted or boiled aromatic coconuts are not yet made easy to open, as a result, in order to have one, the consumers must either have the vendor opened it or open it by themselves at home. In case of take-home consumptions, it requires the skills in using a knife to open the coconut which is not only difficult to pursue and inconvenient for consumption but using the knife to open the coconut shell. Having conducted several related studies and researches, several coconut-related inventions were found, e.g. inventions related to young coconuts but without groove engraving, coconut-opening device such as one having circular saw provided along with the coconut to be used by consumers. Such device, however, is still not easy to use. Furthermore, the production of roasted or boiled aromatic coconut with groove engraved thereon with engraving tools such as a saw, a knife or other sharp objects remains problematic. For example, the use of the aforementioned tools results in grooves which are too wide and not deep enough which make opening coconut shell rather difficult.

Therefore, the concept of the roasted or boiled aromatic coconut which allows easy consumption anywhere, any time and does not requires any specialized skill to open the coconut shell was developed. After years of numerous trials employing several methods, techniques and tools, the most efficient techniques in terms of solution to the existing problems, cost-effectiveness and method for producing the coconut of the present invention is developed.

### SUMMARY

An easy-to-open roasted or boiled aromatic coconut is provided that comprises a coconut from which the husk was removed until a clean shelled coconut is obtained and a groove line on the shell of the coconut, characterized in that said groove line is at least one converged groove line located at the bottom side of the shell of the coconut and that said groove line is made by laser engraving with a laser engraver. In addition, easy-to-open roasted or boiled aromatic coconut also comprises an opening means fixed within one converged groove line, near the groove line.

A method for producing easy-to-open roasted or boiled aromatic coconut is also provide that comprises the steps of; preparing the roasted or boiled aromatic coconut by removing the husk until the clean shelled coconut is obtained and making the easy-to-open roasted or boiled aromatic coconut characterized in that said making the easy-to-open roasted or boiled aromatic coconut consists of engraving the bottom side of the coconut to provide groove line which forms at least one converged groove line by laser engraving using a laser engraver. Preferably, the distance between the laser head and the target area of the coconut shell equals the focal length of the laser head. The present method for producing easy-to-open roasted or boiled aromatic coconut further comprises the step of fixing the opening means within one converged groove line, near the groove line.

At least one object is to provide easy-to-open roasted or boiled aromatic coconut and the method for producing the same in order to obtain roasted or boiled aromatic coconut that allows easy consumption. Consumers can open the aromatic coconut of this invention by pulling the provided opening means such as a pull-ring. In case where at least one converged groove line consists of one large circle groove and one small circle groove within which the pull-ring is fixed near the circle, the coconut shell within the small circle groove can be opened, revealing the coconut meat inside. Through such opening, a tube can be inserted for drinking the coconut juice. When the juice is drunk up, consumers can easily pull the coconut shell within the large circle groove off by hand to eat the coconut meat inside. This is the solution to the difficulty and inconvenience arising upon consumption of roasted or boiled aromatic coconut as well as the prevention of the danger such as from using a knife to open the coconut shell.

### BRIEF DESCRIPTION OF THE DRAWINGS

FIG. 1 shows a clean shelled coconut from which all husk was removed, and on which groove lines are provided according to an embodiment;

FIG. 2 shows the position of the hole, pierced in proximity to one converged groove line, for fixing the opening means to the coconut shell according to an embodiment; and

FIG. 3 shows the position of the opening device such as a pull-ring to be fixed to the coconut shell by using a rivet via the hole pierced within the small circle groove, near the circle groove, according to an embodiment.

### DETAILED DESCRIPTION

The following detailed description is merely exemplary in nature and is not intended to limit the various embodiments or the application and uses thereof. Furthermore, there is no intention to be bound by any theory presented in the preceding background or the following detailed description.

An easy-to-open roasted or boiled aromatic coconut is developed through numerous researches. According to data about the thickness of conventional roasted or boiled aromatic coconuts sold at various places that has been collected over a long period of time, the average thickness of conventional roasted or boiled aromatic coconuts is about 1.2-1.5 mm. depending on the age: for younger or older aromatic coconuts, the thickness can be less or more.

The main tool for producing easy-to-open roasted or boiled aromatic coconut is a laser engraver for engraving a groove on the coconut shell. With the laser engraver, the groove engraving is found to be highly precise, resulting in grooves having a very small width.

The opening device according to an embodiment is preferably a pull-ring, more preferably, an aluminum pull-ring, to be fixed on the coconut shell, near the engraved groove for easy opening. Where a rivet is used to fix the pull-ring, piercing tool such as a drill, may be used to drill the coconut shell near the groove line to an appropriate depth of about 1-1.2 mm and not all the way through the shell.

The aromatic coconuts selected to be processed preferably come from a reliable source, e.g., highly experienced coconut farmers or plants reputable in producing and selecting quality aromatic coconuts having an appropriate shell thickness, age as well as pleasant juice taste to make roasted or boiled aromatic coconut.

The coconuts suitable for the production should be of a diameter of between about 10-12 cm. to match the size of the jig used in the production. Furthermore, the coconuts should be of the appropriate size and age: not too old or too young. To make sure that consumers will have quality coconuts, in the course of production, the coconuts are randomly selected to examine the shell thickness, the quality and the taste of meat and juice.

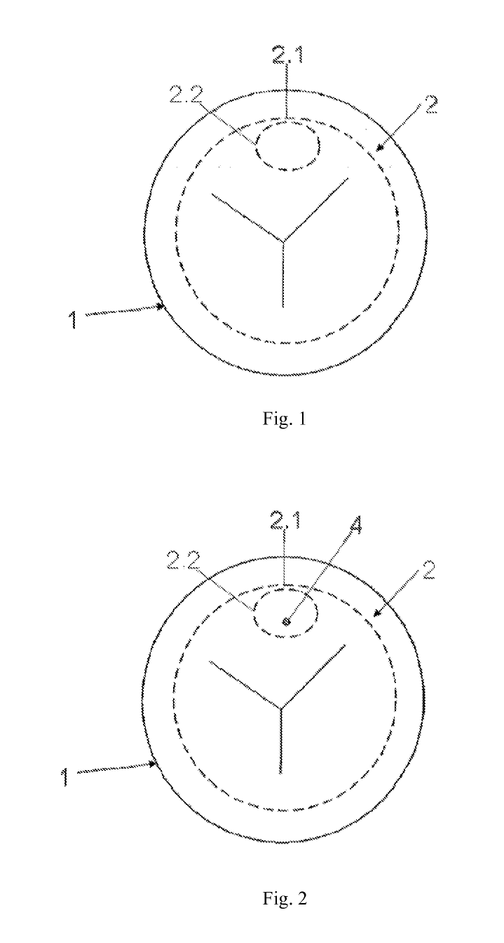

Hereinafter, the easy-to-open roasted or boiled aromatic coconut and the method for producing the same according to embodiments will be described further in detail with reference to the drawings wherein the FIG. 1 to FIG. 3 shows an embodiment without limiting the scope of the present invention to such exemplary embodiment.

As shown in FIG. 1 to FIG. 3, the easy-to-open roasted or boiled aromatic coconut comprising a coconut (1) from which the husk was removed until a clean shelled coconut is obtained and groove line (2) on the shell of the coconut (1), characterized in that said groove line (2) is at least one converged groove line located at the bottom side of the shell of the coconut (1) and that said groove line (2) is made by laser engraving with a laser engraver, giving the groove line (2) the advantage of having a very small and consistent width.

Easy-to-open roasted or boiled aromatic coconut according to the embodiment further comprises an opening means 3 which is fixed within one converged groove line, near the groove line, advantageously allowing easier and more convenient opening of the coconut shell.

At least one converged groove line at the bottom side of the shell of the coconut 1 is preferably provided at a distance from the center of the shell of the coconut (1) and preferably, the at least one converged groove line forms one large circle groove (2.1) and one small circle groove (2.2), which is located within the large circle groove (2.1) near the circle groove. Advantageously, this allows easy opening of the coconut shell because the area located at a position far from the center of the shell of the coconut (1) has less thickness compared to the area located closer to the center of the shell of the coconut (1). The large circle groove (2.1) may have a diameter of about 7.5-8 cm. while the small circle groove (2.2) may have a diameter of about 1.5-3 cm, allowing both circles to be located at a position far from the center of the shell of the coconut (1). Such diameters may be changed based on the size of the coconut (1). Preferably, both the large circle groove and the small circle groove (2.1, 2.2) have a depth of groove of about 1-1.2 mm, which does not cut through the shell and allows easy opening of the coconut.

Easy-to-open roasted or boiled aromatic coconut according to the present invention further comprises a hole (4), for fixing the opening means (3), provided within one converged groove line, near the groove line. The hole (4) for fixing the opening device (3) is preferably provided within the small circle groove (2.2), near the circle groove. Preferably the opening device (3) is a pull-ring, and more preferably, an aluminum pull-ring. Advantageously, a pull-ring, especially an aluminum pull-ring makes a durable opening device that allows easy opening. In addition, the non-corrosive property of aluminum will add to the protection from possible contamination of the coconut meat and coconut juice.

The method for producing easy-to-open roasted or boiled aromatic coconut comprises preparing the roasted or boiled aromatic coconut by removing the husk until the clean shelled coconut is obtained and making the easy-to-open roasted or boiled aromatic coconut characterized in that the making the easy-to-open roasted or boiled aromatic coconut consists of; engraving the bottom side of the shell of the coconut (1) to provide at least one converged groove line (2) by laser engraving using a laser engraver. In order to obtain the groove line (2) having a very small and consistent width, preferably, the distance between the laser head and the target area of the coconut shell equals the focal length of the laser head.

The method for producing Easy-to-open roasted or boiled aromatic coconut also comprises fixing the opening device (3) within one converged groove line, near the groove line, which gives the advantage of easy opening of the coconut.

Engraving the bottom side of the shell of the coconut (1) to provide groove line (2) that forms at least one converged groove line, is preferably conducted at a position far from the center of the shell of the coconut (1) to provide one large circle groove (2.1) and one small circle groove (2.2) that is located within the large circle groove (2.1), near the circle groove. Preferably, the depth of groove of both circle grooves (2.1, 2.2) equals about 1-1.2 mm. to advantageously prevent the laser beam from cutting through the shell and thereby hitting the coconut meat inside. If the grooves are too deep, both the coconut meat and juice inside will be exposed to air, facilitating the growth of microorganisms that can leads to fouling of the coconut meat and juice. If the grooves are too shallow, opening the coconut will become rather difficult.

The method for producing Easy-to-open roasted or boiled aromatic coconut further comprises piercing the bottom side of the shell of the coconut (1) near one converged groove line to provide a hole (4) for fixing the opening device (3) that is preferably a pull-ring, and more preferably, an aluminum pull-ring. However, the opening device (3) is not limited to only the pull-ring.

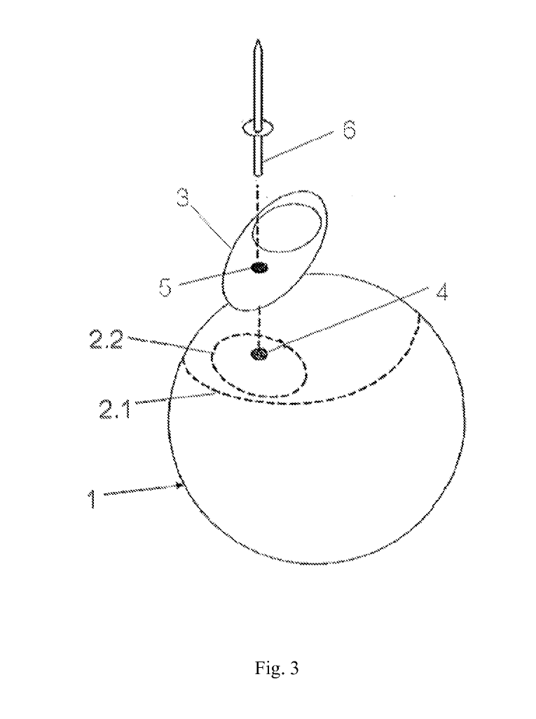

The piercing the bottom side of the shell of the coconut (1) near one converged groove line to provide a hole (4) is preferably piercing the coconut shell to provide the hole (4) within the small circle groove (2.2), near the circle groove, for fixing the pull-ring using a rivet (6) that is passed through the hole (5) of the pull-ring to the hole (4) as shown in FIG. 3, which illustrates an opening device (3) as a pull-ring as well as how the a pull-ring is to be fixed, by using a rivet (6) which will be passed through the hole (5) of the pull-ring to the hole (4).

The foregoing description is subject to any changes of embodiments and production process without departing from the scope and spirit of the present invention. While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

1. An easy-to-open aromatic coconut, comprising
a coconut; and
a groove line on engraved on a shell of the coconut using a laser,
wherein in said groove line is at least one converged groove line located at a bottom side of the shell of the coconut.

2. The easy-to-open aromatic coconut according to claim 1, further comprising an opening device fixed within the at least one converged groove line and near the groove line.

3. The easy-to-open coconut according to claim 1,
wherein the at least one converged groove line located at the bottom side of the shell of the coconut at a distance from the center of the shell of the coconut,
wherein said at least one converged groove line forms a large circle groove and a small circle groove that is located within the large circle groove near the circle groove both the large circle groove and the small circle groove have a depth of groove of about 1-1.2 mm.

4. The easy-to-open aromatic coconut according to claim 1, further comprising a hole to fix the opening device provided within one converged groove line that is near the groove line.

5. The easy-to-open aromatic coconut according to claim 4, wherein the hole to fix the opening device is within the small circle groove and near the circle groove

6. A method for producing an easy-to-open coconut, comprising:
removing the husk to a clean shelled coconut;
laser engraving a bottom side of the shell of the coconut with a laser engraver to provide groove line that forms at least one converged groove line

7. The method for producing the easy-to-open aromatic coconut according to claim 6, further comprising fixing an opening device within at least one converged groove line that is near the groove line.

8. The method for producing the easy-to-open aromatic coconut according to claim, wherein the laser engraving of the bottom side of the shell of the coconut to provide the groove line, which forms the at least one converged groove line, is conducted at a position far from the center of the shell of the coconut to provide a large circle groove and a small circle groove that is located within the large circle groove near the circle groove

9. The method for producing the easy-to-open aromatic coconut according to claim 6, further comprising piercing the bottom side of the shell of the coconut near the converged groove line to provide a hole to fix the opening device

10. The method for producing the easy-to-open aromatic coconut according to claim 9, wherein said piercing the bottom side of the shell of the coconut near the converged groove line to provide a hole comprises piercing the coconut shell to provide the hole within the small circle groove (2.2) near the circle groove to fix the pull-ring using a rivet that is passed through a pull-ring hole of the pull-ring to the hole.

11. The easy-to-open aromatic coconut according to claim 1, wherein the easy-to-open aromatic coconut is a roasted aromatic coconut.

12. The easy-to-open aromatic coconut according to claim 1, wherein the easy-to-open aromatic coconut is a boiled aromatic coconut.

13. The easy-to-open aromatic coconut according to claim 5, wherein the opening device is a pull-ring.

14. The easy-to-open aromatic coconut according to claim 13, wherein the pull-ring is an aluminum pull-ring.

15. The method for producing the easy-to-open aromatic coconut according to claim 6, wherein the easy-to-open aromatic coconut is a roasted aromatic coconut.

16. The method for producing the easy-to-open aromatic coconut, wherein the easy-to-open aromatic coconut is a roasted aromatic coconut.

17. The method for producing the easy-to-open aromatic coconut according to claim 6, where a distance between the laser head and a target area of the coconut shell equals the focal length of the laser head.

18. The method for producing the easy-to-open aromatic coconut according to claim 8, wherein the large circle groove and the small circle groove have a depth of groove of about 1-1.2 mm.

19. The method for producing the easy-to-open aromatic coconut according to claim 9, wherein the opening device is preferably a pull-ring.

20. The method for producing the easy-to-open aromatic coconut according to claim 19, wherein the pull-ring is an aluminum pull-ring.
